(19) United States
(12) Patent Application Publication
(10) Pub. No.: US 2007/0181380 A1
(43) Pub. Date: Aug. 9, 2007

(54) Panel assembly with trim plates

(76) Inventor: Glenn A. Bostock, Bryn Athyn, PA (US)

Correspondence Address: SYNNESTVEDT & LECHNER, LLP, 1101 MARKET STREET, 26TH FLOOR, PHILADELPHIA, PA, 19107-2950, US

(21) Appl. No.: 11/336,549

(22) Filed: Jan. 20, 2006

(51) Int. Cl. B66B 11/02

(52) U.S. Cl. 187/401

(57) ABSTRACT

A panel assembly is disclosed having finishing elements in the form of trim plates. Interchangeable panels of the assembly having tongue and groove edges are attached to a support structure. The trim plates are positioned along free edges of panels at the top and bottom of the assembly. The trim plates have mounting surfaces that engage respective contact surfaces on the panels. The mounting and contact surfaces are offset away from a center plane of the panels toward a back face that interfaces with the support structure to which the panel assembly is attached. The offset provides enhanced structural safety by reducing bending moments on fasteners effecting attachment of the panel assembly to the support structure.

### FIELD OF THE INVENTION

This invention relates to panel assemblies having trim plates especially useful to finish elevator cab interiors.

### BACKGROUND OF THE INVENTION

In the construction of elevators, it is advantageous to provide an interior that is architecturally pleasing. This is often accomplished by mounting decorative panels onto the elevator cab or cage. The panels may display rich wood grain, mirrored surfaces, brushed steel or decorative embossments or moldings and serve to hide the functional appearance of the elevator cab. Trim plates, for example, kick plates positioned adjacent to the floor of the cab, and crown plates, positioned adjacent to the ceiling of the cab, are also useful to complete the cab interior.

Decorative panels and the trim plates may be heavy and, therefore, require robust attachment to the supporting structure provided by the elevator cab. Because the elevator cab is not a static structure, the panels and trim plates are subjected to inertial loads when the cab is accelerated during starting and stopping. Particularly high forces are induced during testing of the elevator, when interior panels and trim plates have been known to break free of their mountings and fall into the interior of the elevator cab.

Mounting of the panels is a challenge because the mounting must be robust while not compromising the decorative aspects of the elevator's interior design. It is also preferable to mount the panels and trim plates from the interior of the cab because there is limited space between the cab and the elevator shaft which makes access to the mounting hardware difficult. The cab interior should also be proof against vandalism so that it is difficult to remove the various interior elements.

In view of the history and potential for elevator panel failure, as well as the desired characteristics of ease of assembly and resistance to vandalism, there is clearly a need for a design that better fulfills all of the requirements of structural integrity and architectural acceptance while incorporating all of the interior components in an integrated design.

### SUMMARY OF THE INVENTION

The invention concerns a panel assembly attachable to a support structure. The panel assembly comprises a panel having a back face. The back face interfaces with the support structure upon attachment of the panel thereto. A contact surface is located on the panel and oriented transversely thereto. The contact surface is offset from the center plane of the panel toward the back face. A trim plate is positioned along the contact surface of the panel. The trim plate has a mounting surface engaged with the contact surface at an interface therebetween when the trim plate and the panel are attached to the support structure.

The panel assembly may also include an opposite contact surface positioned on the panel in opposed relation to the contact surface. The opposite contact surface is oriented transversely to the panel and offset from the center plane of the panel toward the back face. A second trim plate is positioned along the opposite contact surface. The second trim plate has a mounting surface engaged with the opposite contact surface when the second trim plate and the panel are attached to the support structure.

The invention also includes an elevator cab comprising a cab structure and a top panel, a bottom panel and at least one intermediate panel, all attached to the cab structure. The intermediate panel is positioned between the top and bottom panels. The panels are arranged substantially co-planar with one another and form an interior wall of the cab. The top panel has a back face. The back face interfaces with the cab structure upon attachment of the top panel thereto. A contact surface is located on the top panel and oriented transversely thereto. The contact surface it is offset from the center plane of the top panel toward the back face. A crown plate is attached to the cab structure. The crown plate is positioned along the contact surface and has a mounting surface engaged with the contact surface. The bottom panel may comprise a back face which interfaces with the cab structure upon attachment of the bottom panel thereto. A bottom contact surface is positioned on the bottom panel. The bottom contact surface is oriented transversely to the bottom panel and is offset from the center plane of the bottom panel toward the back face. A kick plate is positioned along the bottom contact surface. The kick plate has a mounting surface engaged with the bottom contact surface when the kick plate and the bottom panel are attached to the support structure.

The invention also concerns a method of installing a panel assembly onto a support. The method comprises:
providing a top panel having a back face and a contact surface oriented transversely to the top panel, the contact surface being offset from the center plane of the top panel toward the back face;
attaching the top panel to the support structure such that the back face interfaces with the support structure; and
attaching a trim plate to the support structure along the contact surface, the trim plate having a mounting surface engaged with the contact surface.

The method may further include:
providing a bottom panel having a back face and a bottom contact surface oriented transversely to the bottom panel, the bottom contact surface being offset from the center plane of the bottom panel toward the back face;
attaching the bottom panel to the cab structure such that the back face interfaces with the support structure; and
attaching a second trim plate to the support structure along the bottom contact surface, the trim plate having a mounting surface engaged with the bottom contact surface.

### BRIEF DESCRIPTION OF THE DRAWINGS

FIG. 1 is a perspective view of a panel assembly according to the invention used in an elevator cab; and

FIG. 2 is a sectional view showing a panel assembly according to the invention on an enlarged scale.

### DETAILED DESCRIPTION OF THE EMBODIMENTS

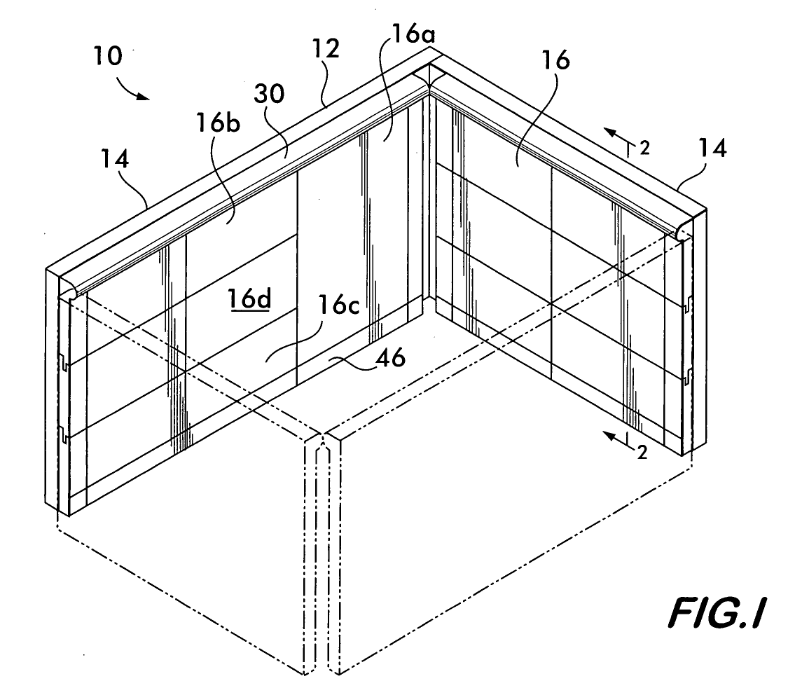

FIG. 1 shows a panel assembly 10 attached to a support structure 12, in this example, the interior of an elevator cab 14. It is understood that the panel assembly is not limited to use in elevator cabs, but may be attached to any structure wherein an aesthetically pleasing surface is desired. Elevator cab 14 is of course positionable within an elevator shaft of a building and is vertically movable within the shaft between floors of the building as is well understood.

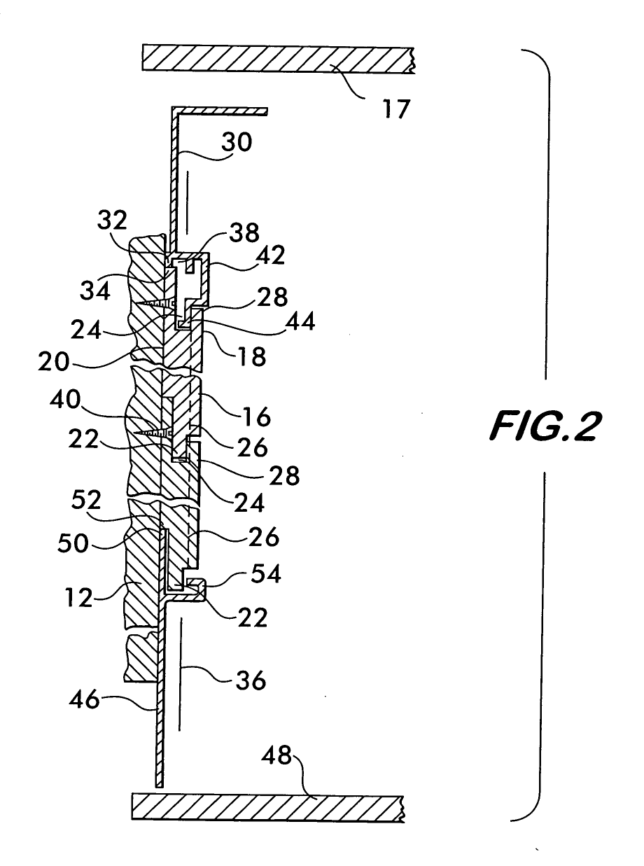

Panel assembly 10 is shown in detail in FIG. 2 and comprises one or more panels 16. Each panel has a front face 18 displaying a decorative surface and a back face 20 oppositely disposed to the front face. Back face 20 interfaces with the support structure 12 to which the panels are attached. Panels 16 preferably interlocked with one another using a tongue 22 and groove 24 positioned along opposite edges 26 and 28 of each panel. The panels are preferably interchangeable in that each has a tongue 22 positioned along one edge and a groove 24 positioned along the opposite edge. Panels 16 preferably engage one another as disclosed in co-pending application Ser. No. 09/490,268, hereby incorporated by reference.

To complete the decorative aspect of the panels, a trim plate, as exemplified by crown plate 30, is used to cover any support structure 12 which might be exposed or visible near an edge 28 of a panel 16. Crown plate 30 is preferably an extrusion and may be formed of polymeric materials or metals such as steel, brass and aluminum. Crown plate 30 may be attached to the support structure 12 or the panel 16 adjacent to the ceiling 17 of the structure and has a mounting surface 32 that engages the panel 16 along a contact surface 34. Contact surface 34 is located offset from the center plane 36 of the panel toward the back face 20 and is oriented transversely to that plane. The interface 38 between the contact surface 34 and the mounting surface 32 defines the load path for the weight of the trim plate on the panels below it. Because of the aforementioned offset of these surfaces 32 and 34 toward the back face, the dead weight of the trim plate as well as the inertial loads induced when the elevator is accelerated or decelerated is kept close to the support structure 12. This positioning of the load path mitigates any bending moments experienced by fasteners such as screws 40 used to attach the panel assembly to the support structure. Reducing the bending moments on the fasteners allows the panel assembly to withstand greater inertial forces without the risk of breaking away from the support structure, as often happens during safety tests or cable failures for panel assemblies wherein the load path passes through the center plane of the panel or at or near the front face 18.

Although crown plate 30 can have any appearance, including a particular shape and surface finish complementary to the panels 16, in a preferred embodiment, the crown plate includes a lengthwise extending flange 42 positioned overlying the interface 38 between the contact surface 34 and the mounting surface 32. Flange 42 serves to hide the interface as well as any adjacent fasteners which may be visible, thereby completing the aesthetic display. The crown plate flange 42 may also have a lengthwise extending tongue 44 attached, the tongue projecting from the flange and into the groove 24 of the panel 16. Again, the tongue 44 enhances the aesthetic appeal of the panels by forming a visually pleasing seam between the trim plate and the panel.

Additional finishing pieces included in the panel assembly 10 may comprise a kick plate 46. Kick plate 46 is so named because it usually is positioned at the lowermost boundary of the panel assembly where it provides a visual aesthetic enhancement near a floor 48. Kick plate 46 has a mounting surface 50 that is engageable with a contact surface 52 on the panel 16 to which it is adjacent. The panel contact surface 52 is offset from the center plane 36 of the panel 16 toward the back face 20 of the panel and is oriented transversely to that plane. Again, the offset of the contact surface keeps the load path close to the support structure 12 to mitigate bending loads on any fasteners. Preferably, a lengthwise extending flange 54 is attached to the kick plate 46. Kick plate flange 54 is positioned in overlying relation with tongue 22 to cover the tongue and present a neat, finished appearance to the panel assembly. Like the crown plate 30, kick plate 46 is preferably an extrusion, and may be formed from polymer materials or metal.

As shown in FIG. 1, the panel assembly 10 may comprise a single panel 16a along with either or both a crown plate 30 and a kick plate 46, or the crown and/or kick plates and a plurality of panels including a top panel 16b, a bottom panel 16c, and one or more intermediate panels 16d positioned between the top and bottom panels.

Panel assemblies according to the invention allow finishing elements, such as trim plates, to be incorporated while still maintaining structural advantages allowing moving structures, such as elevator cabs, to operate with enhanced safety even under conditions of rapid acceleration or deceleration.

What is claimed is:

1. A panel assembly attachable to a support structure, said panel assembly comprising:
a panel having a back face, said back face interfacing with said support structure upon attachment of said panel thereto;
a contact surface located on said panel and oriented transversely thereto, said contact surface being offset from the center plane of said panel toward said back face; and
a trim plate positioned along said contact surface of said panel, said trim plate having a mounting surface engaged with said contact surface at an interface therebetween when said trim plate and said panel are attached to said support structure.

2. A panel assembly according to claim 1, wherein said trim plate comprises a lengthwise extending flange positioned adjacent to said mounting surface, said flange being in overlying relation with said interface between said mounting surface and said contact surface.

3. A panel assembly according to claim 2, further comprising:
a groove extending along said panel adjacent to said contact surface, said groove being offset from the center plane of said panel away from said back face; and
a lengthwise extending tongue attached to said flange, said tongue projecting from said flange into said groove.

4. A panel assembly according to claim 1, further comprising:
an opposite contact surface positioned on said panel in opposed relation to said contact surface, said opposite contact surface being oriented transversely to said panel and offset from the center plane of said panel toward said back face; and
a second trim plate positioned along said opposite contact surface, said second trim plate having a mounting surface engaged with said opposite contact surface when said second trim plate and said panel are attached to said support structure.

5. A panel assembly according to claim 4, further comprising:
a tongue positioned adjacent to said opposite contact surface and extending lengthwise along said panel; and
a lengthwise extending second flange attached to said second trim plate, said second flange being positioned in overlying relation with said tongue.

6. A panel assembly attachable to a support structure, said panel assembly comprising:
a top panel, a bottom panel, and at least one intermediate panel positioned between said top and bottom panels, said panels being arranged substantially co-planar with one another;
said top panel having a back face, said back face interfacing with said support structure upon attachment of said top panel thereto;
a contact surface located on said top panel and oriented transversely thereto, said contact surface being offset from the center plane of said top panel toward said backface; and
a crown plate positioned along said contact surface, said crown plate having a mounting surface engaged with said contact surface when said crown plate and said top panel are attached to said support structure.

7. A panel assembly according to claim 6, wherein said crown plate comprises a lengthwise extending crown plate flange positioned adjacent to said mounting surface, said crown plate flange being in overlying relation with an interface between said mounting surface and said contact surface.

8. A panel assembly according to claim 7, further comprising:
a groove extending along said top panel adjacent to said contact surface, said groove being offset from the center plane of said panel away from said back face; and
a lengthwise extending tongue attached to said crown plate flange, said tongue projecting from said crown plate flange into said groove.

9. A panel assembly according to claim 6, wherein said bottom panel comprises:
a back face, said back face interfacing with said support structure upon attachment of said bottom panel thereto;
a bottom contact surface positioned on said bottom panel, said bottom contact surface being oriented transversely to said bottom panel and offset from the center plane of said bottom panel toward said back face; and
a kick plate positioned along said bottom contact surface, said kick plate having a mounting surface engaged with said bottom contact surface when said kick plate and said bottom panel are attached to said support structure.

10. A panel assembly according to claim 9, further comprising:
a tongue positioned adjacent to said bottom contact surface and extending lengthwise along said bottom panel; and
a lengthwise extending kick plate flange being attached to said kick plate in overlying relation with said tongue.

11. An elevator cab comprising:
a cab structure;
a top panel, a bottom panel, and at least one intermediate panel attached to said cab structure, said intermediate panel being positioned between said top and bottom panels, said panels being arranged substantially co-planar with one another and forming an interior wall of said cab;
said top panel having a back face, said back face interfacing with said cab structure upon attachment of said top panel thereto;
a contact surface located on said top panel and oriented transversely thereto, said contact surface being offset from the center plane of said top panel toward said backface; and
a crown plate attached to said cab structure, said crown plate being positioned along said contact surface, said crown plate having a mounting surface engaged with said contact surface.

12. An elevator cab according to claim 11, wherein said crown plate comprises a lengthwise extending crown plate flange positioned adjacent to said mounting surface, said crown plate flange being in overlying relation with an interface between said mounting surface and said contact surface.

13. An elevator cab according to claim 12, further comprising:
a groove extending along said top panel adjacent to said contact surface, said groove being offset from the center plane of said panel away from said back face; and
a lengthwise extending tongue attached to said crown plate flange, said tongue projecting from said crown plate flange into said groove.

14. An elevator cab according to claim 11, wherein said bottom panel comprises:
a back face, said back face interfacing with said cab structure upon attachment of said bottom panel thereto;
a bottom contact surface positioned on said bottom panel, said bottom contact surface being oriented transversely to said bottom panel and offset from the center plane of said bottom panel toward said back face; and
a kick plate positioned along said bottom contact surface, said kick plate having a mounting surface engaged with said bottom contact surface when said kick plate and said bottom panel are attached to said support structure.

15. An elevator cab according to claim 14, further comprising:
a tongue positioned adjacent to said bottom contact surface and extending lengthwise along said bottom panel; and
a lengthwise extending kick plate flange being attached to said kick plate in overlying relation with said tongue.

16. A method of installing a panel assembly onto a support structure, said method comprising:
providing a top panel having a back face and a contact surface oriented transversely to said top panel, said contact surface being offset from the center plane of said top panel toward said back face;
attaching said top panel to said support structure such that said back face interfaces with said support structure; and
attaching a trim plate to said support structure along said contact surface, said trim plate having a mounting surface engaged with said contact surface.

17. A method according to claim 16, further comprising:
providing a bottom panel having a back face and a bottom contact surface oriented transversely to said bottom panel, said bottom contact surface being offset from the center plane of said bottom panel toward said back face;
attaching said bottom panel to said support structure such that said back face interfaces with said support structure; and
attaching a second trim plate to said support structure along said bottom contact surface, said second trim plate having a mounting surface engaged with said bottom contact surface.
